(19) United States
(12) Patent Application Publication
(10) Pub. No.: US 2019/0162423 A1
(43) Pub. Date: May 30, 2019

(54) COMPONENT FOR CONNECTING A HYDRAULIC UNIT OF A HEATING DEVICE

(71) Applicant: Robert Bosch GmbH, Stuttgart (DE)

(72) Inventors: Andreas Stegemeyer, Ludwigsburg (DE); Manfred Oehrlein, Schlierbach (DE); Marcus Wuenning, Shanghai (CN); Yildirim Cantuerk, Esslingen (DE)

(21) Appl. No.: 15/949,833

(22) Filed: Apr. 10, 2018

(30) Foreign Application Priority Data
Nov. 30, 2017 (DE) 102017221504.6

(51) Int. Cl. F24D 19/02; F16M 13/02

(52) U.S. Cl. CPC F24D 19/0209; F16M 13/02

(57) ABSTRACT

A component for connecting a hydraulic unit of a heating device, which includes at least one means for the attachment to a housing structure. The at least one means for the attachment to a housing structure is developed as a plug-in element. A device for connecting a hydraulic unit of a heating device, which includes at least one component for connecting a hydraulic unit of a heating device is also provided. The component is disposed so as to be exchangeable. A heating device, which has at least one hydraulic unit, is also described. The hydraulic unit is fixed in place on a housing structure of the heating device via an exchangeable component. A method for mounting a hydraulic unit of a heating device is also described.

### CROSS REFERENCE

The present application claims the benefit under 35 U.S.C. § 119 of German Patent Application No. DE 102017221504.6 filed on Nov. 30, 2017, which is expressly incorporated herein by reference in its entirety.

The present invention relates to a component for connecting a hydraulic unit of a heating device, said component having at least one means for an attachment to a housing structure. In addition, the present invention relates to a device for connecting a hydraulic unit of a heating device, which includes at least one component for connecting a hydraulic unit of a heating device. The present invention furthermore relates to a heating device, which includes at least one hydraulic unit, and the present invention also relates to a method for mounting a hydraulic unit of a heating device.

### BACKGROUND INFORMATION

In conventional heating devices, hydraulic units such as heat exchangers are attached to a housing structure with the aid of rivets or screws.

### SUMMARY

In accordance with the present invention, an example component for connecting a hydraulic unit of a heating device, said component having at least one means for an attachment to a housing structure, may offer an advantage that the at least one means for an attachment to a housing structure is developed as a plug-in element and thereby makes the mounting on the housing structure easier.

Advantageous further developments of the present invention are described herein. For example, it is advantageous that the at least one means for an attachment to a housing structure includes at least one guide element and/or at least one detent element, in particular a snap-in hook, which allows for a particularly secure attachment to the housing structure.

It is advantageous if the component includes at least one means for supporting a hydraulic unit, which may be used for mounting a hydraulic unit on the component.

The at least one means for supporting a hydraulic unit is preferably developed as a type of pin, in particular as at least one pin, for an insertion into the hydraulic unit, which provides an especially stable connection of a hydraulic unit.

The present invention also relates to a device for connecting a hydraulic unit of a heating device, which has at least one component for connecting a hydraulic unit of a heating device, in particular at least one component according to the preceding description. The device offers the advantage that the component is disposed in an exchangeable manner, thereby making it possible, depending on the requirements, to use different components of this type for the connection of different hydraulic units.

It is advantageous if at least one receptacle for the at least one component is developed so that a stable plug-in connection is possible.

It is especially preferred if the at least one receptacle is introduced into a housing structure of the heating device, which thereby allows for a particularly stable attachment of a hydraulic unit to a housing structure.

The present invention also relates to a heating device, which includes at least one component as described above, and/or at least one device as described above. The at least one component and/or the at least one device make(s) it possible to install different hydraulic units in the heating device, according to the requirements.

In the same way, the present invention relates to a heating device that has at least one hydraulic unit and may offer the advantage that the hydraulic unit is fixed in place on a housing structure of the heating device via an exchangeable component, in particular a component according to the preceding description. The exchangeable component thus makes it possible to easily exchange even an already installed hydraulic unit.

In addition, the present invention relates to a method for mounting a hydraulic unit of a heating device. The present method has the advantage that the following method steps are carried out:
a) Plugging, especially latching, at least one component into a housing structure of a heating device;
b) Plugging a hydraulic unit onto or into the at least one component,
thereby allowing for an especially rapid and simple mounting.

### BRIEF DESCRIPTION OF THE DRAWINGS

Exemplary embodiments of the present invention are schematically shown in the figures and are described in greater detail below.

FIG. 1 shows a perspective view of an exemplary embodiment of a component for connecting a hydraulic unit of a heating device.

FIG. 2 shows a further perspective view of the exemplary embodiment of the component from FIG. 1.

FIG. 3 shows a perspective view of an exemplary embodiment of a device for connecting a hydraulic unit of a heating device.

FIG. 4 shows a further perspective view of the exemplary embodiment of the device from FIG. 3.

FIG. 5 shows a further perspective view of the exemplary embodiment of the device from FIG. 3 and FIG. 4.

FIG. 6 shows a perspective cutaway of an exemplary embodiment of a heating device as an exploded drawing.

FIG. 7 shows a perspective cutaway of the exemplary embodiment of the heating device after components for connecting a hydraulic unit have been inserted.

FIG. 8 shows a perspective cutaway of the exemplary embodiment of the heating device after a hydraulic unit has been plugged in.

FIG. 9 shows a perspective view of a further exemplary embodiment of a component for connecting a hydraulic unit of a heating device.

FIG. 10 shows a further perspective view of the exemplary embodiment of the component from FIG. 9.

### DETAILED DESCRIPTION OF EXAMPLE EMBODIMENTS

FIG. 1 shows a perspective view of an exemplary embodiment of a component 10 for connecting a hydraulic unit of a heating device. Component 10 for connecting a hydraulic unit of a heating device, which includes a means 12 for an attachment to a housing structure, is characterized by a development of means 12 for the attachment to a housing structure in the form of a plug-in element 14, which thus allows for a simplified mounting on the device structure of a heating device without the use of screws.

Means 12 for the attachment to a housing structure has at least one guide element 16 and/or at least one detent element 18, i.e. a snap-in hook 20 in the illustrated case, which allows for a particularly secure attachment and simplified mounting on a housing structure. Guide element 16 has a flat design and includes an opening 21. Snap-in hook 18 projects through opening 21 so that it is able to reach into a housing structure.

In addition, guide element 16 includes a mechanical coding 24 at a corner 22, which permits only one preferred orientation in a plug-in connection. In the illustrated case, mechanical coding 24 is a corner 26 that is beveled in comparison with the other corners.

Component 10 also includes a means 28 for supporting a hydraulic unit, which makes it possible to mount a hydraulic unit without a direct fastening to a housing structure via component 10. This makes it possible to mount a hydraulic unit on a housing structure of a heating device in a modular fashion.

Means 28 for supporting the hydraulic unit is developed as a type of pin, i.e. as a pin 30 in the illustrated case, for an insertion into a hydraulic unit, which thus allows for a particularly stable connection of a hydraulic unit.

In the illustrated exemplary embodiment, pin-type means 28, or pin 30, for the support of a hydraulic unit has a profile in the form of a cross so that a guided and form-locked insertion is possible when connecting a hydraulic unit.

In addition, means 28 for supporting a hydraulic unit, or pin 30, has rounded regions 34 at a tip 32 so that an insertion into a hydraulic unit during the mounting is simplified.

In the illustrated exemplary embodiment, component 10 furthermore has a base element 36. Disposed on base element 36 are both means 12 for the attachment to a housing structure, or plug-in element 14, with guide element 16 and snap-in hook 18, as well as means 28, or pin 30, for supporting a hydraulic unit. In the illustrated case, base element 36 is developed in the shape of a cube.

Moreover, on a side facing plug-in element 14, component 10 has a beveled edge 38. In the illustrated case, beveled edge is situated on base element 36. Beveled edge 38 simplifies an insertion of component 10 because jamming is avoided because of beveled edge 38.

In the illustrated exemplary embodiment, component 10 is made from plastic and thus is able to be produced in an economical manner. It is also possible to develop component 10 as one piece, e.g., using an injection-molding method.

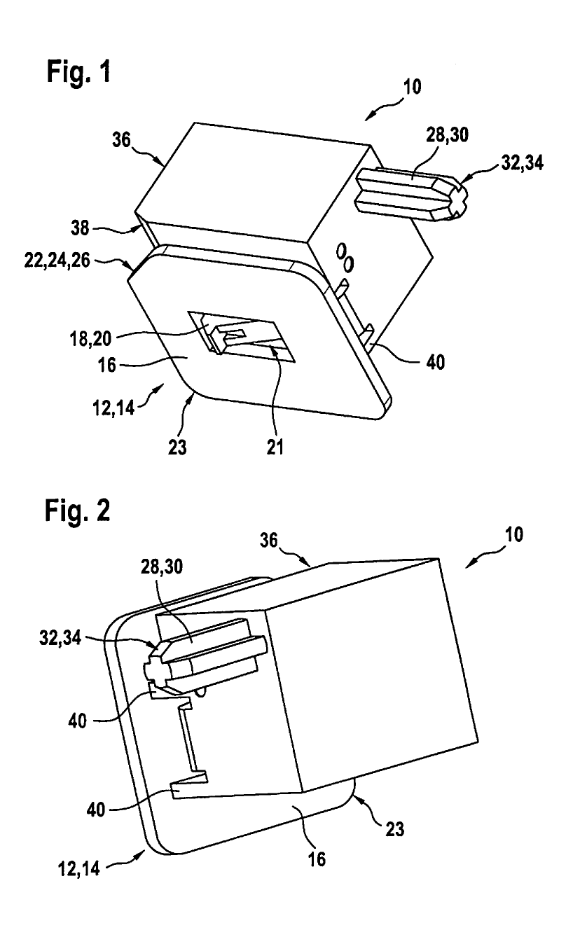

A further perspective view of the exemplary embodiment of component 10 from FIG. 1 is shown in FIG. 2. There, too, it is clear that base element 38 has the shape of a cube.

It can furthermore be gathered that guide element 16 is attached to base element 36 via webs 40, and detent element 18, or snap-in hook 20, directly adjoins base element 36.

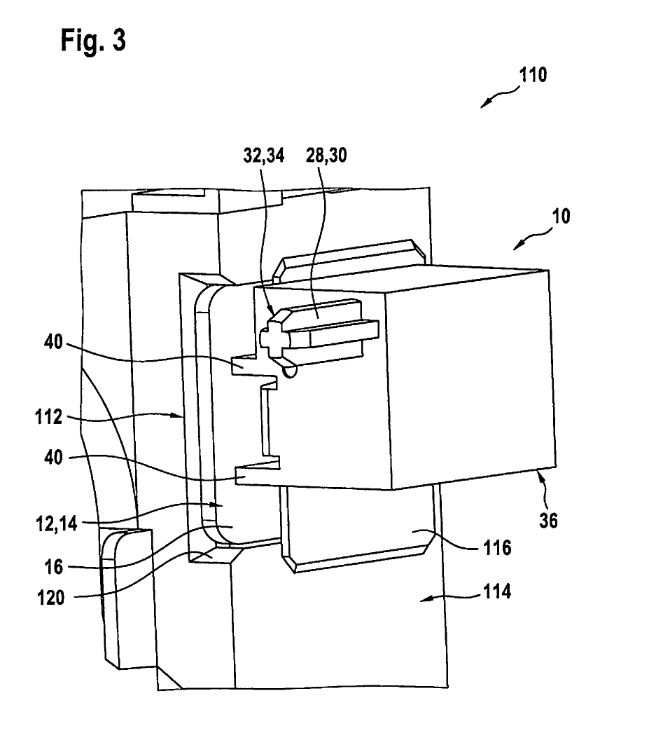

FIG. 3 shows a perspective view of an exemplary embodiment of a device 110 for connecting a hydraulic unit of a heating device. Device 110 for connecting a hydraulic unit of a heating device, which includes a component 10 for the connection of a hydraulic unit of a heating device, i.e., component 10 of the exemplary embodiments from FIGS. 1 and 2 in the illustrated exemplary embodiment, is characterized in that component 10 is disposed in an exchangeable manner. Depending on the respective requirement, it is therefore possible to use different components of this type for connecting different hydraulic units.

In the illustrated exemplary embodiment, a receptacle 112 is developed for component 10. Receptacle 112 is introduced into a housing structure 114 of the heating device. Due to receptacle 112, a stable mounting of component 10, and thus also of a hydraulic unit, is possible on housing structure 114.

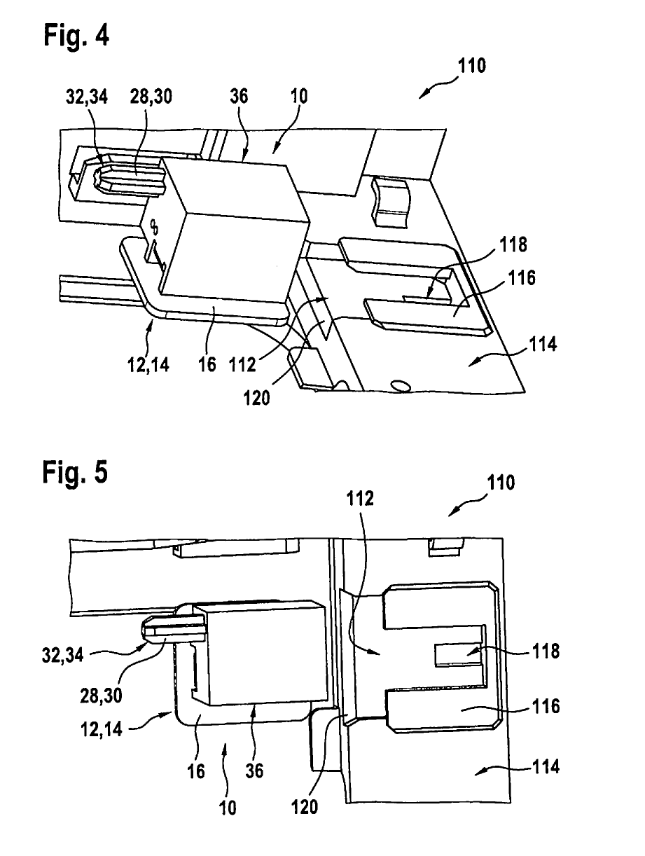

FIG. 4 shows a further perspective view of the exemplary embodiment of device 110 from FIG. 3; in this instance, component 10 is depicted outside of receptacle 112 for better clarity. The illustration thus also makes it clear that component 10 is disposed so as to be exchangeable. The mounting of component 10 on housing structure 114 is accomplished by inserting plug-in element 14, or guide element 16 including detent element 18, into receptacle 112.

Receptacle 112 is covered by a projection 116, which holds component 10 when it is inserted into receptacle 112. In addition, receptacle 112 includes a recess 118 in which detent element 18, or snap-in hook 20, locks into place so that component 10 is securely fixated during the insertion into receptacle 112.

In addition, receptacle 112 has beveled edges 120, which simplifies the insertion of component 10.

FIG. 5 shows a further perspective view of the exemplary embodiment of device 110 from FIGS. 3 and 4. Here, too, component 10 is shown outside receptacle 112 for a clearer depiction. Also quite visible in the illustration is recess 118 in which detent element 18, or snap-in hook 20, locks into place when component 10 is inserted.

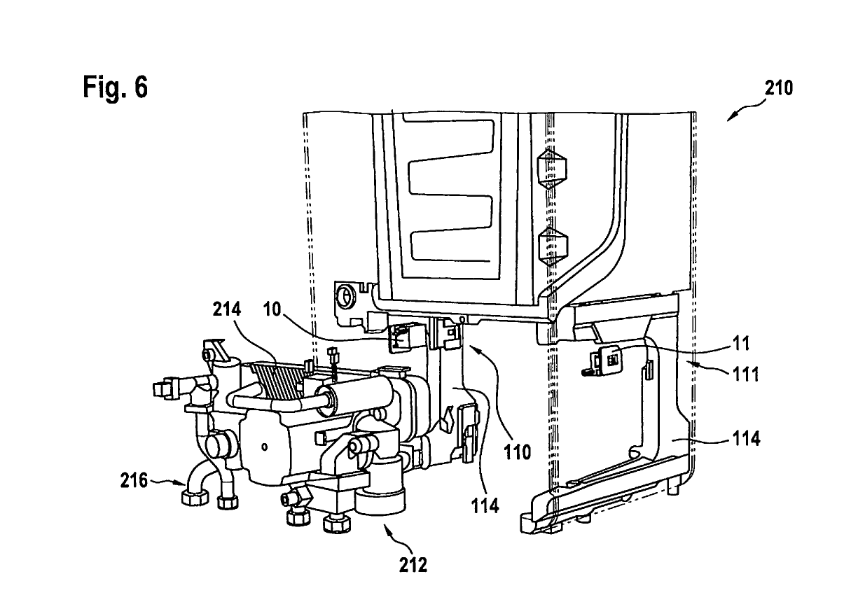

FIG. 6 shows a perspective cutaway of an exemplary embodiment of a heating device 210 in the form of an exploded view. Heating device 210 has a component 10 according to the specific embodiment from FIGS. 1 and 2, as well as a further component 11. In the illustrated exemplary embodiment, further component 11 has a similar development as component 10 but differs in that mechanical coding 24 is developed on further corner 23 rather than on corner 22.

Alternatively, however, it would also be possible that component 10 and further component 11 have an identical development.

In addition, heating device 210 includes a device 110 according to the exemplary embodiment from FIGS. 3 through 5, as well as a further device 111. Further device 111 includes further component 11 for connecting hydraulic unit 212. In the illustrated exemplary embodiment, device 110 and further device 111 are disposed opposite each other.

The use of components 10, 11 or devices 110, 111 allows for a particularly simple mounting of a hydraulic unit 212.

Hydraulic unit 212 heats water when heating device 210 is in operation, e.g., for a heating circuit or for a raw water requirement. Accordingly, hydraulic unit 212 is equipped with elements that are able to carry out such heating of water. In the illustrated case, hydraulic unit 212 has a plate-type heat exchanger 214 and connection fittings 216. In addition, hydraulic unit 212 may include further elements that contribute to the intended function.

In the illustrated exemplary embodiment, component 10 and further component 11 are disposed so as to be exchangeable. In the same way, hydraulic unit 212 is similarly situated in an exchangeable manner on housing structure 114 of heating device 210 via exchangeable component 10 and further exchangeable component 11. This makes it possible, if desired, to uninstall hydraulic unit 212 in a relatively simple manner and to exchange it for some other hydraulic unit depending on the type of device of heating device 210.

Hydraulic unit 212 is installed in the heating device by carrying out the following steps:
a) Inserting, i.e., snapping in the illustrated case, component 10 and further component 11 into housing structure 114 of heating device 210;
b) Plugging hydraulic unit 212 into component 10 and further component 11, i.e. in the illustrated case onto pin-type means 28 or pins 30 of component 10 and further component 11.

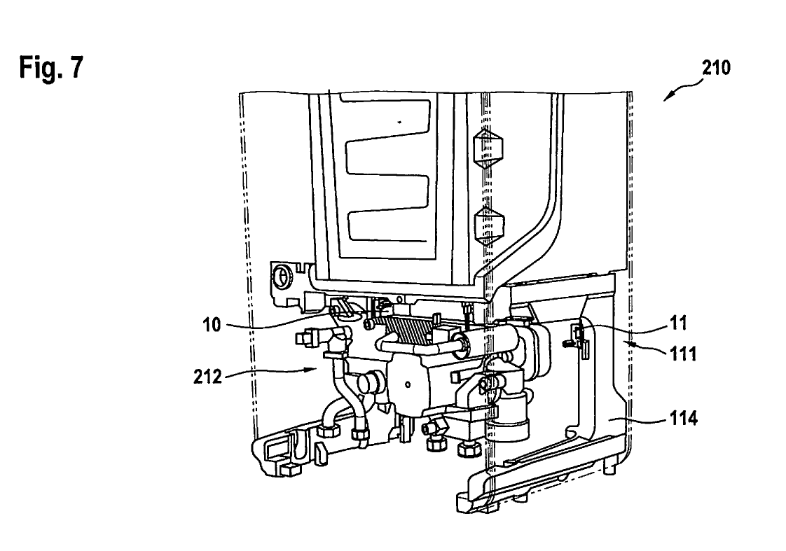

FIG. 7, according to step a), shows a perspective cutaway of the exemplary embodiment of heating device 210 from FIG. 6 after component 10 and further component 11 have been inserted for the connection of hydraulic unit 212. Component 10 and further component 11 are situated opposite each other.

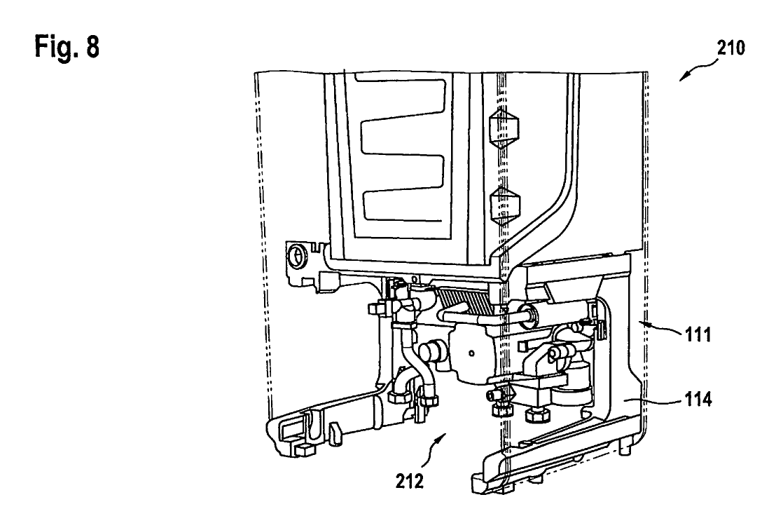

FIG. 8, according to step b), shows a perspective cutaway of the exemplary embodiment of heating device 210 after hydraulic unit 212 has been plugged into pin-type means 28, or pins 30, of component 10 and further component 11. Components 10, 11 have a carrying effect and are generally responsible for supporting hydraulic unit 212.

Accordingly, FIGS. 6 through 8 represent a mounting sequence of hydraulic unit 212.

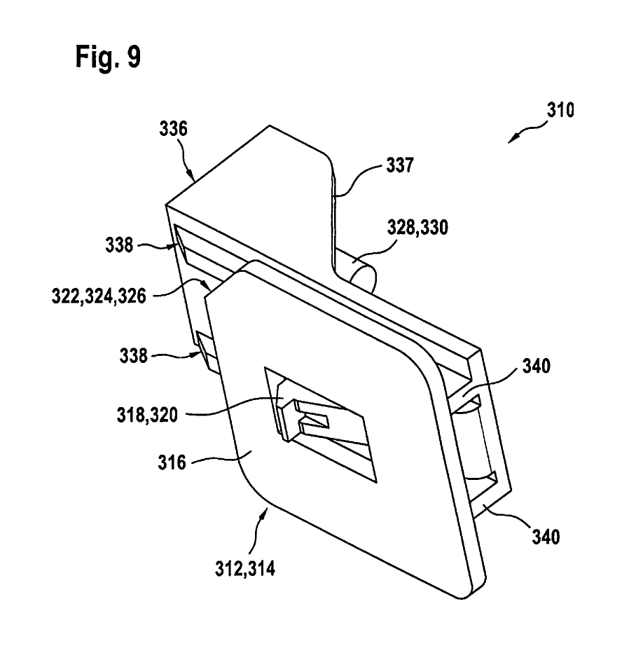

Depending on the device type of a heating device, different hydraulic units with different components for connecting these hydraulic units are able to be mounted in a flexible manner. Depending on the development of a hydraulic unit to be connected, a component may be adapted for the connection to this hydraulic unit so that a stable support of the corresponding hydraulic unit is able to be provided. For instance, FIG. 9 shows a perspective view of a further exemplary embodiment of a component 310 for the connection of a hydraulic unit of a heating device.

Component 310, for instance, may also be used for device 110 of the exemplary embodiment according to FIGS. 3 and 4, and/or for heating device 210 of the exemplary embodiment according to FIGS. 6 through 8, and it is possible to mount some other hydraulic unit that is compatible with component 310.

Similar to component 10 of the exemplary embodiment according to FIGS. 1 and 2, this component 310 also includes a means 312 for an attachment to a housing structure. It, too, is characterized in that means 312 for the attachment to a housing structure in developed as a plug-type element 314. As a result, component 310 provides the same technical advantages as component 10 from the exemplary embodiment according to FIGS. 1 and 2.

Component 310 is generally identically constructed as component 10 from the exemplary embodiment according to FIGS. 1 and 2. For instance, the one means 312 for an attachment to a housing structure includes a guide element 316 and a detent element 318, which is also a snap-in hook 320 in the illustrated case.

Component 310 also includes a mechanical coding 324 at one corner 322, which allows only one preferred orientation in a plug-in connection. In the illustrated case, mechanical coding 324 is a corner 326 that is beveled in comparison with the other corners, as is also the case in component 10 of the exemplary embodiment according to FIGS. 1 and 2.

However, component 310 differs from component 10 of the exemplary embodiment according to FIGS. 1 and 2 in that base element 336 of component 310 has an essentially rectangular and flat design. Moreover, base element 336 is clearly longer in its dimensions than plug-in element 312, which includes guide element 316 and detent element 318. Due to said development of base element 336, it is possible to save space inside a heating device, which in turn allows for a larger design of a hydraulic unit to be installed.

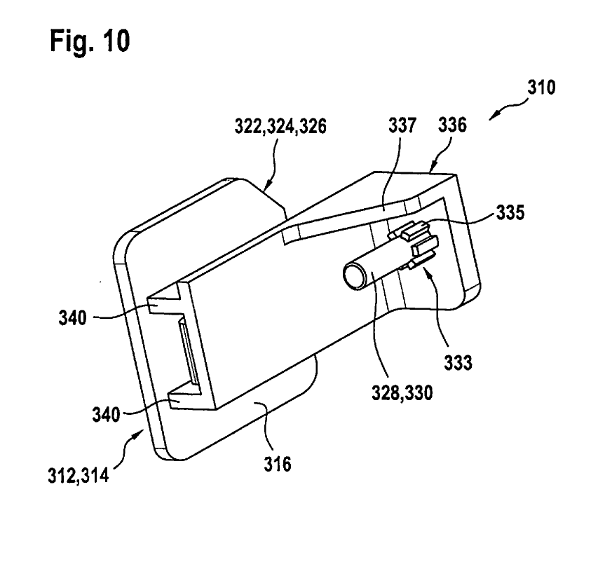

FIG. 10 shows a further perspective view of the exemplary embodiment of component 310 from FIG. 9. It can be seen that component 310 also includes a means 328 for supporting a hydraulic unit, which is developed in the form of a pin, i.e., as a pin 330 in the illustrated case, for an insertion into a hydraulic unit. In the illustrated exemplary embodiment, means 328 for supporting a hydraulic unit has a generally cylindrical design. It includes projections 335 that are disposed in the form of a star in a base region 333 and allow for a form-locking connection of a hydraulic unit.

Furthermore, component 310 has a support wall 337, which provides further stability to a hydraulic unit.

It can be gathered from FIG. 10 that guide element 316 is connected to base element 336 by way of webs 340, and detent element 318, or snap-in hook 320, directly adjoins base element 336.

FIG. 9 in turn illustrates that webs 340 are provided with beveled edges 338 on a side that is in front during an insertion into a housing structure, which facilitates an insertion into the housing structure.

What is claimed is:

1. A component for connecting a hydraulic unit of a heating device, the component comprising:
at least one means for an attachment to a housing structure, the at least one means for the attachment to a housing structure being a plug-in element.

2. The component as recited in claim 1, wherein the at least one means for the attachment to a housing structure includes at least one of: (i) at least one guide element, (ii) at least one detent element, and (iii) a snap-in hook.

3. The component as recited in claim 1, wherein the component has at least one means for supporting a hydraulic unit.

4. The component as recited in claim 3, wherein the at least one means for supporting a hydraulic unit is at least one pin for an insertion into a hydraulic unit.

5. A device for connecting a hydraulic unit of a heating device, the device comprising:
at least one component for connecting a hydraulic unit of a heating device, the component including at least one means for an attachment to a housing structure, the at least one means for the attachment to a housing structure being a plug-in element;
wherein the component is disposed so as to be exchangeable.

6. The device as recited in claim 5, wherein at least one receptacle is developed for the at least one component.

7. The device as recited in claim 6, wherein the at least one receptacle is in a housing structure of the heating device.

8. A heating device, comprising at least one of:
a component for connecting a hydraulic unit of a heating device, the component including at least one means for an attachment to a housing structure, the at least one means for the attachment to a housing structure being a plug-in element; and
a device including the component, wherein the component is disposed so as to be exchangeable.

9. A heating device, comprising:
at least one hydraulic unit attached to a housing structure of the heating device via an exchangeable component, the component including at least one means for an attachment to a housing structure, the at least one means for the attachment to a housing structure being a plug-in element.

10. A method for mounting a hydraulic unit of a heating device, comprising:
a) latching at least one component into a housing structure of a heating device; and
b) plugging a hydraulic unit into and/or onto the at least one component.
